(19) United States
(12) Patent Application Publication
(10) Pub. No.: US 2013/0020040 A1
(43) Pub. Date: Jan. 24, 2013

(54) Sunshade Assembly Having a Locking Mechanism

(71) Applicant: Paul Lin, Tainan City (TW)

(72) Inventor: Paul Lin, Tainan City (TW)

(21) Appl. No.: 13/186,591

(22) Filed: Jul. 20, 2011

(51) Int. Cl. B60J 3/02

(52) U.S. Cl. 160/370.22

(57) ABSTRACT

A sunshade assembly includes a winding shaft, a sunshade cloth wound around the winding shaft, and a pull rod connected to one end of the sunshade cloth. A guide unit includes a base seat disposed below a housing of the sunshade assembly, and a guide rod having a top end connected to the pull rod. A locking mechanism includes a push-push lock mounted on the base seat, and a latch unit fixed to the guide rod and having an engaging tongue. When the sunshade cloth is pulled upward by the pull rod to a stretched position, the guide rod is moved upward so that the engaging tongue pushes and engages the push-push lock. When the guide rod is moved further upward, the engaging tongue pushes again the push-push lock and disengages therefrom, thereby permitting the sunshade cloth to be wound automatically by the winding shaft to a wound position.

### BACKGROUND OF THE INVENTION

1. Field of the Invention

The invention relates to a sunshade assembly, and more particularly to a sunshade assembly that is adapted to be installed on a side window of a vehicle.

2. Description of the Related Art

To prevent sunlight from directly radiating into an interior of a vehicle, a layer of insulating film is generally adhered to the window of the vehicle. Some vehicle owners install a sunshade assembly on the side window to further shade the interior of the vehicle from sunlight. Hence, a variety of sunshade assemblies have been developed and sold in the market. Some are motor-operated sunshade assemblies, and others are manually-operated sunshade assemblies. Some include a combination of motor- and manually-operated sunshade assemblies. The unwinding operation may be performed manually, while the winding operation may be performed automatically.

### SUMMARY OF THE INVENTION

Therefore, an object of the present invention is to provide a sunshade assembly having a novel structure and that is easy to use.

According to this invention, a sunshade assembly comprises a housing having a top opening, a winding shaft mounted rotatably in the housing, a sunshade cloth wound around the winding shaft, a pull rod connected to one end of the sunshade cloth that is distal from the winding shaft and disposed outside the top opening, a guide unit, and a locking mechanism. The guide unit includes a base seat disposed below the housing and extending in a top-bottom direction, and a guide rod mounted to and slidable upward and downward along the base seat and having a top end connected to the pull rod. The locking mechanism includes a push-push lock mounted on the base seat, and a latch unit fixed to the guide rod and having an engaging tongue engageable releasably with the push-push lock. When the sunshade cloth is pulled upward by the pull rod from a wound position to a stretched position, the guide rod is moved upward by the pull rod so that the engaging tongue pushes and engages the push-push lock. When the guide rod is moved further upward, the engaging tongue pushes again the push-push lock and disengages therefrom, thereby permitting the sunshade cloth to be wound automatically by the winding shaft from the stretched position to the wound position.

The advantages of this invention reside in that through the push-push locking configuration of the locking mechanism, the sunshade cloth can be moved manually to and positioned at the stretched position. Afterwards, by moving the guide rod further upward so that the engaging tongue can push again the push-push lock and disengage therefrom, the sunshade cloth can be wound automatically by the winding shaft from the stretched position to the wound position. Hence, use of the present invention is relatively easy.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a sunshade assembly according to the preferred embodiment of the present invention;

FIG. 2 is a fragmentary exploded perspective view of a guide unit, a locking mechanism, a release unit and a damping unit of the preferred embodiment;

FIG. 3 is a fragmentary sectional side view of the preferred embodiment in an assembled state;

FIG. 4 is a view similar to FIG. 3, but illustrating a guide rod of the guide unit being moved further upward so that an engaging tongue of the locking mechanism can push again a push-push lock;

FIG. 5 is a view similar to FIG. 3, but illustrating the engaging tongue being disengaged from the push-push lock;

FIG. 6 is a fragmentary sectional side view of the preferred embodiment, illustrating a side window of a vehicle contacting a roller of the release unit;

FIG. 7 is a view similar to FIG. 6, but illustrating how the side window presses the release unit to rotate so that the engaging tongue pushes again the push-push lock; and

FIG. 8 is a view similar to FIG. 6, but illustrating the engaging tongue being disengaged from the push-push lock.

### DETAILED DESCRIPTION OF THE PREFERRED EMBODIMENT

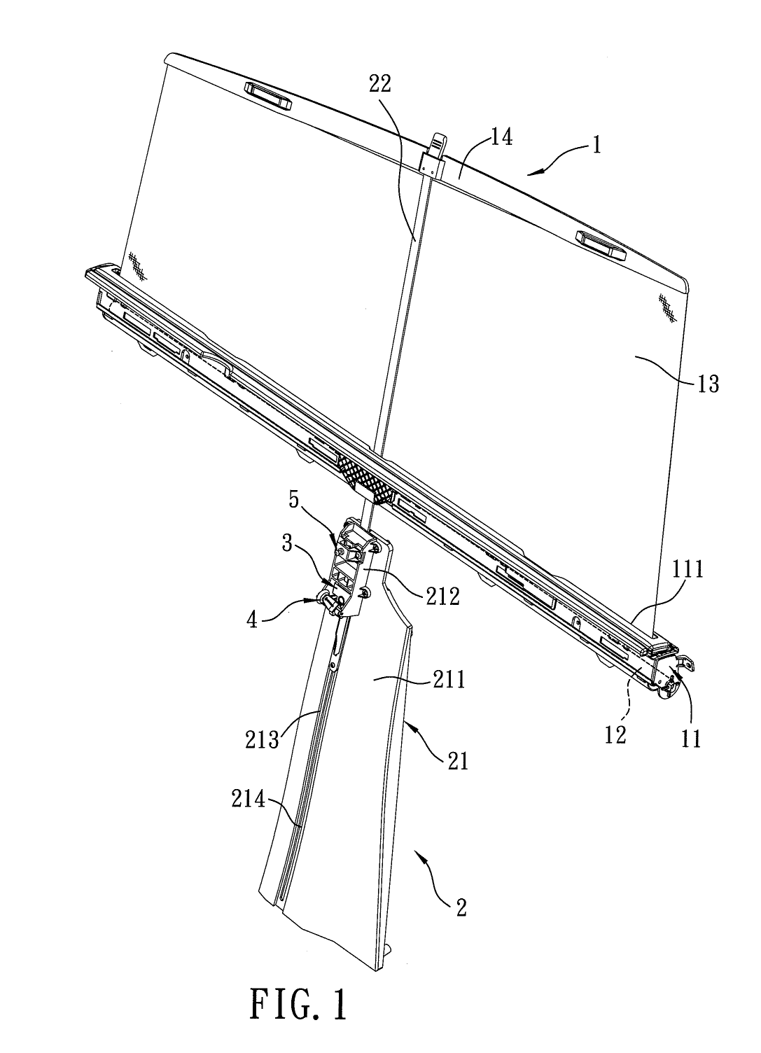

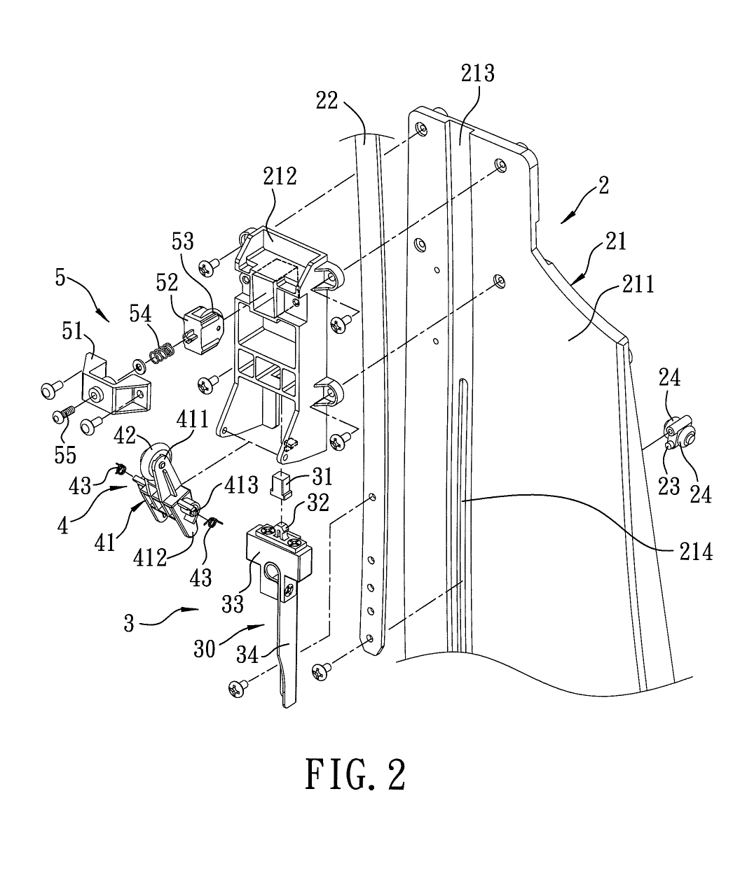

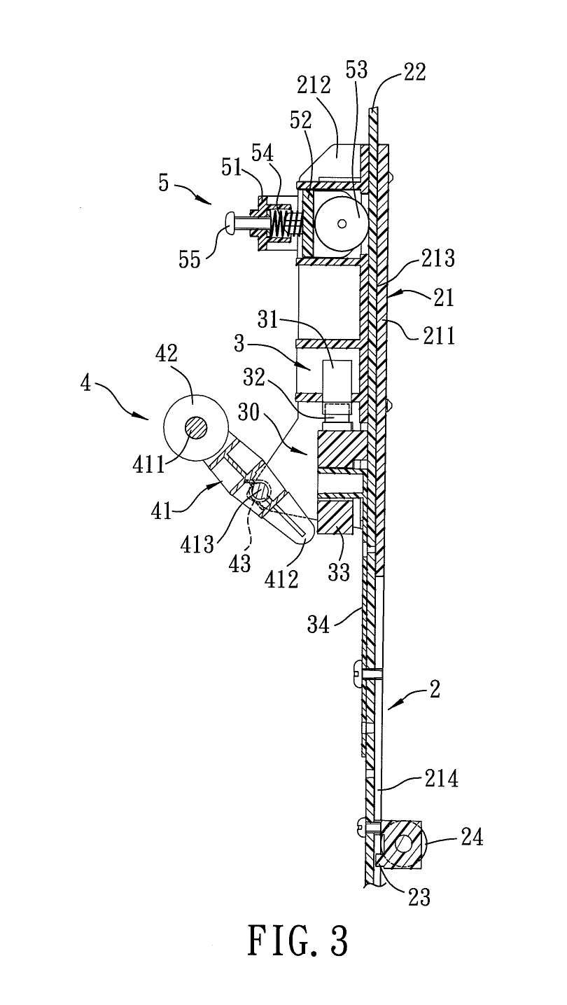

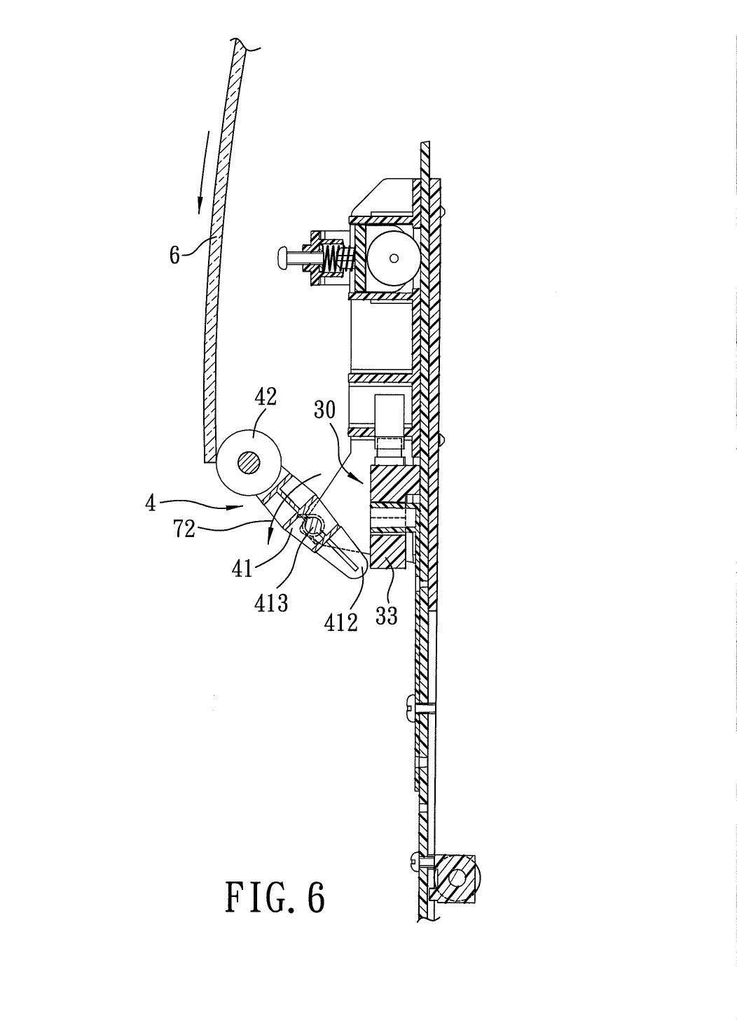

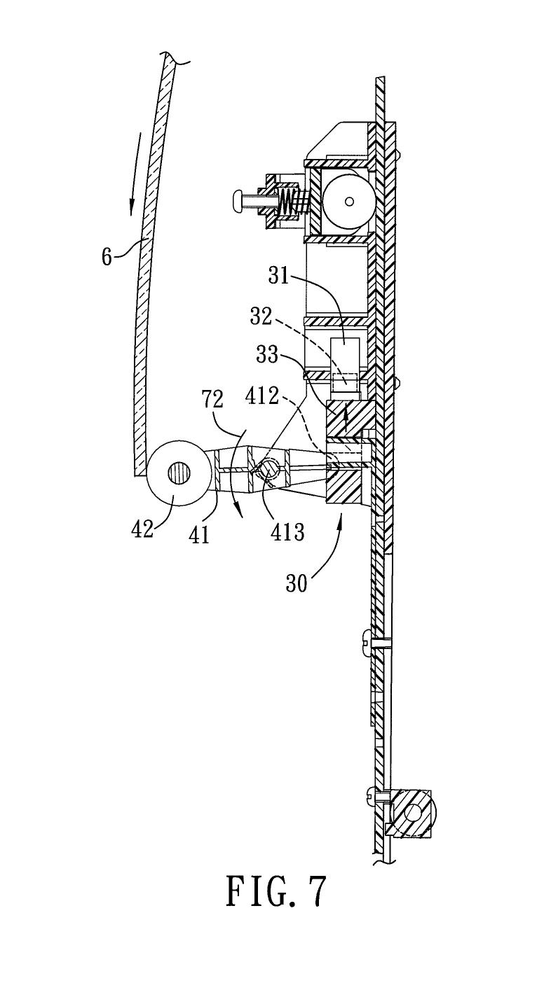

Referring to FIGS. 1 to 8, a sunshade assembly according to the preferred embodiment of the present invention comprises a sunshade unit 1, a guide unit 2, a locking mechanism 3, a release unit 4, and a damping unit 5. The sunshade assembly of the present invention is adapted to be installed on a door (not shown) of a vehicle, and corresponds in position to one side of a side window 6 (see FIG. 6) that is proximate to a seat (not shown) of the vehicle. Hence, in the following description, an outer side refers to the side that is proximate to the side window 6, and an inner side refers to the side that is proximate to the seat.

The sunshade unit 1 includes a housing 11 having a top opening 111, a rewindable winding shaft 12 mounted rotatably in the housing 11, a sunshade cloth 13 extendably wound around the winding shaft 12, and a pull rod 14 connected to one end of the sunshade cloth 13 that is distal from the winding shaft 12 and disposed outside the top opening 111. The sunshade unit 1 may further include at least one spring element (not shown) having one end that is fixed, and another end connected to the winding shaft 12. The spring element is rotatable along with the winding shaft 12 to provide a winding biasing force to the winding shaft 12 along a winding direction. In the absence of an external force, the sunshade cloth 13 may be automatically wound into the housing 11 by the winding shaft 12. Alternatively, the sunshade unit 1 may have other constructions.

The guide unit 2 includes a base seat 21 disposed below the housing 11 and extending in a top-bottom direction, a guide rod 22 mounted to and slidable upward and downward along the base seat 21 and having a top end connected to the pull rod 14, a slide piece 23 bolted to a bottom end of the guide rod 22, and two pulleys 24 connected respectively to two opposite sides of the slide piece 23 and contacting rollably the base seat 21. The base seat 21 includes a mounting plate 211, and a clamping body 212 bolted to an outer side of the mounting plate 211. However, the structure of the base seat 21 is not limited to the aforesaid disclosures. The base seat 21 further includes a guide groove 213 formed in the outer side of the mounting plate 211 and extending in a top-bottom direction, and a slide hole 214 extending in a top-bottom direction and communicating with the guide groove 213 and an inner side of the mounting plate 211. The guide rod 22 is disposed between the clamping body 212 and the mounting plate 211, and is received slidably in the guide groove 213. The slide piece 23 is slidable in the slide hole 214. The connecting configuration between the guide rod 22 and the guide groove 213 or between the slide piece 23 and the slide hole 214 can be altered, and is not limited to the aforesaid disclosures. Further, although the provision of the slide piece 23, the slide hole 214, and the pulleys 24 is to guide and restrict the guide rod 22 so that the guide rod 22 can slide smoothly, but it is not an important aspect of this invention, so that a detailed description thereof is dispensed herewith.

The locking mechanism 3 includes a push-push lock 31 mounted to the clamping body 212, and a latch unit 30 fixed to the guide rod 22. In this embodiment, the latch unit 30 has a tongue seat 33, an engaging tongue 32 connected to a top end of the tongue seat 33 and engageable releasably with the push-push lock 31, and a connecting rod 34 disposed on the tongue seat 33 opposite to the engaging tongue 34 and bolted to the guide rod 22. In an alternative embodiment, the engaging tongue 32 and the tongue seat 33 may be formed integrally as one piece and may be connected directly to the guide rod 22. In this case, the connecting rod 34 may be dispensed herewith. In this embodiment, the push-push lock 31 is a resilient lock. When the engaging tongue 32 is inserted into and pushes the push-push lock 31, the engaging tongue 32 is locked to the push-push lock 31. When the engaging tongue 32 pushes again the push-push lock 31, the engaging tongue 32 is unlocked from and ejects out of the push-push lock 31. That is, by repeatedly pushing the engaging tongue 32 against the push-push lock 31, the engaging tongue 32 can be locked to and unlocked from the push-push lock 31. Since the push-push lock 31 is conventionally designed, and is not an important aspect of this invention, a detailed description of the same is dispensed herewith.

The release unit 4 is used to move upward the latch unit 30 and to disengage the engaging tongue 32 from the push-push lock 31, and includes a release arm 41 disposed rotatably on an outer side of the clamping body 212 proximate to the locking mechanism 3, a roller 42 mounted on the release arm 41, and two biasing members 43 to provide a returning force to the release arm 41. The release arm 41 has a pressed portion 411, a push portion 412 opposite to the pressed portion 411, and a pivot portion 413 between the pressed portion 411 and the push portion 412 and connected pivotally to a bottom portion of the clamping body 212. The roller 42 is journalled on the pressed portion 411. Each biasing member 43 is disposed between the clamping body 212 and a corresponding front or rear side of the pivot portion 413. The position and number of the biasing members 43 may be altered as required. For example, only one biasing member 43 may be disposed between the clamping body 212 and the center of the pivot portion 413. Further, the biasing member 43 may be a torsion or coiled spring, and is not limited to the aforesaid disclosures.

The damping unit 5 is used to dampen a downward speed of the guide rod 22, and includes a hollow damping seat 51 bolted to the clamping body 212, a wheel seat 52 connected movably to the damping seat 51, a damping wheel journalled on the wheel seat 52 and pressing resiliently the guide rod 22 against the mounting plate 211, a spring member 54 mounted between the damping seat 51 and the wheel seat 52 and biasing the damping wheel 53 to move toward the guide rod 22, and an adjustment screw 55 connected adjustably to the damping seat 53 opposite to the wheel seat 52. The spring member 54 is a compression spring.

In use, the sunshade cloth 13 can be moved relative to the housing 11 between a stretched position, as shown in FIG. 1, and a wound position (not shown). To stretch the sunshade cloth 13 so as to block sunlight, a user grips and pulls upward the pull rod 14, which in turn, pulls the sunshade cloth 13 out of the winding shaft 12. Simultaneously, the guide rod 22 is moved upward by the pull rod 14 until the engaging tongue 32 pushes and engages the push-push lock 31, thereby placing the sunshade cloth 13 in the stretched position.

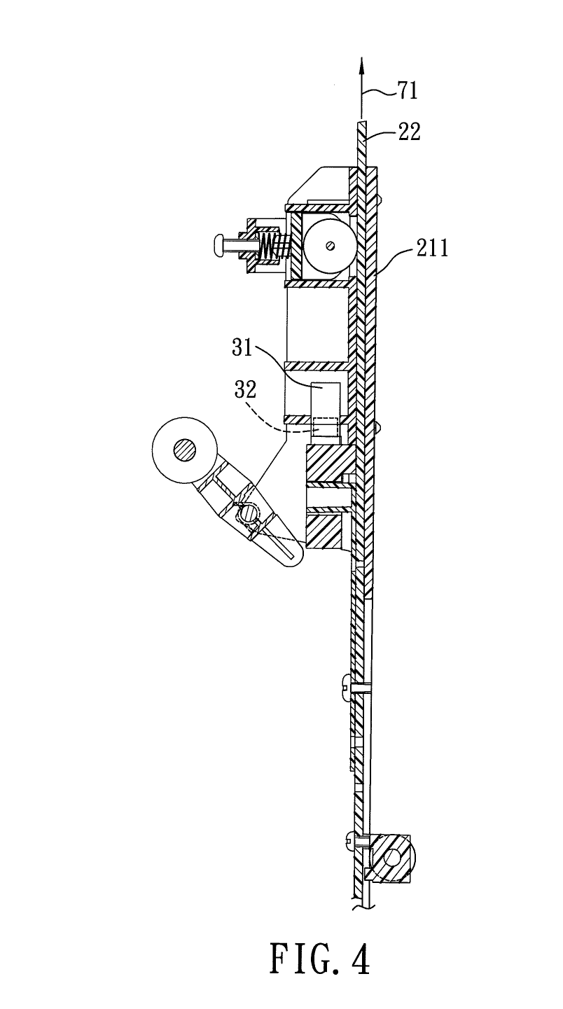

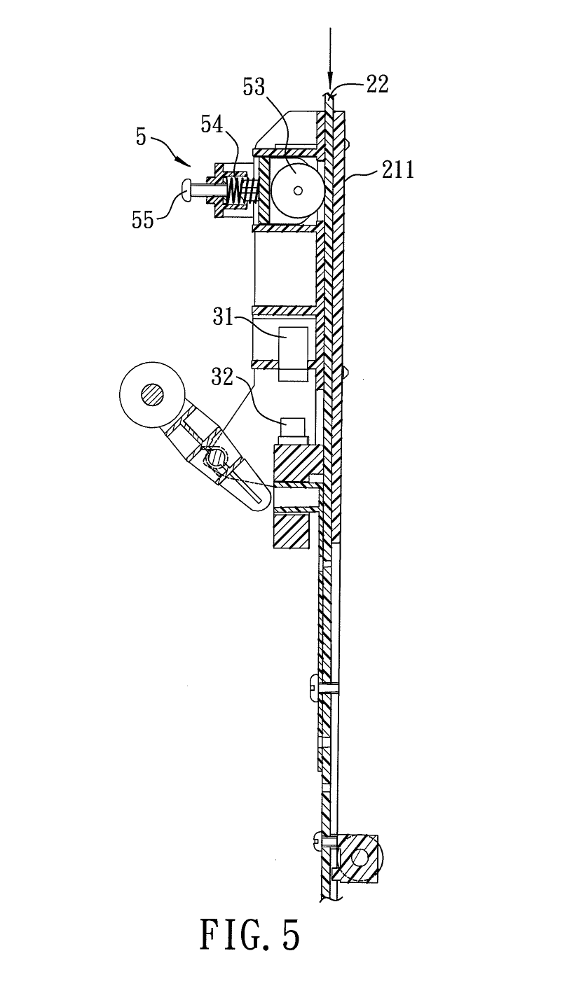

With reference to FIGS. 1 and 4, to wind the sunshade cloth 13 back onto the winding shaft 12, the pull rod 14 is slightly pulled further upward to move the guide rod 22 upward in the direction of an arrow (71) so that the engaging tongue 32 pushes again the push-push lock 31 and disengages therefrom. The pull rod 14 is then released, so that the engaging tongue 32 can move away from the push-push lock 31, as shown in FIG. 5, and so that the sunshade cloth 13 can be wound automatically by the winding shaft 12 from the stretched position to the wound position. At this time, the guide rod 22 is moved downward by the pull rod 14. As the guide rod 22 moves downward, through the damping wheel 53 that presses the guide rod 22 against the mounting body 211, a downward speed of the guide rod 22 is dampened so that the guide rod 22 moves slowly downward. Further, by rotating the adjustment screw 55 to compress or uncompress the spring member 54, the downward speed of the guide rod 22 can be controlled.

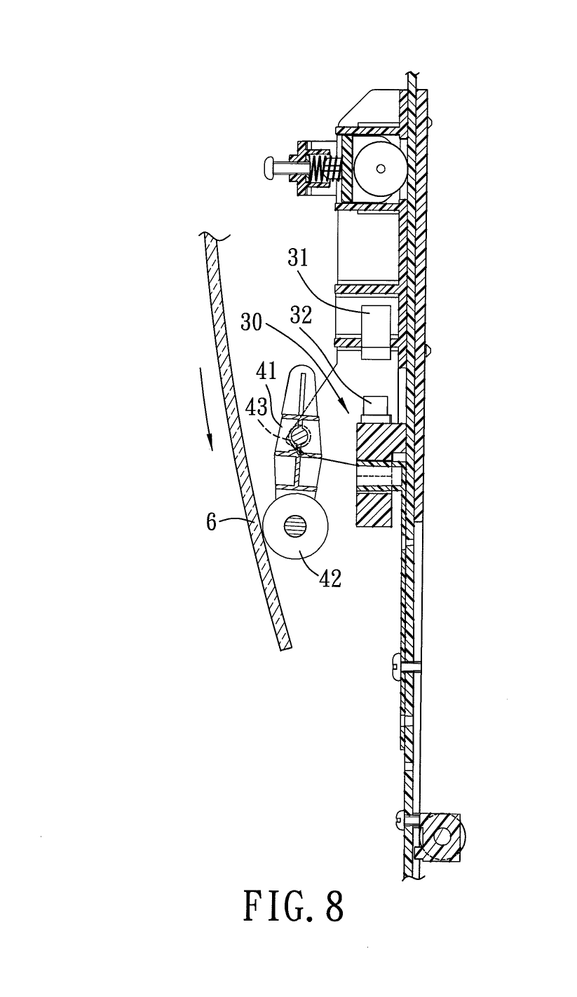

With reference to FIGS. 1, 6, 7, and 8, during the winding operation, the sunshade cloth 13 may be automatically wound through the side window 6. That is, as the side window 6 moves downward, it will contact and press downward the roller 42 of the release unit 4. This causes the release arm 41 to rotate about the pivot portion 413 in the direction of an arrow (72). Simultaneously, the push portion 412 of the release arm 41 pushes upward the latch unit 30 so that the engaging tongue 32 pushes again the push-push lock 31 and disengages therefrom, as shown in FIG. 8. Simultaneously, the side window 6 moves the release arm 41 to rotate and move away from the latch unit 30, and the sunshade cloth 13 (see FIG. 1) is wound automatically by the winding shaft 12 (see FIG. 1) to the wound position. When the roller 42 is pressed and the release arm 41 is rotated, the biasing members 43 store a returning force, so that when the side window 6 is moved upward, the biasing members 43 can bias the release arm 41 to rotate back to its original position.

In summary, the sunshade assembly of the present invention is provided with the locking mechanism 3 so that when the sunshade cloth 13 is stretched, it can be positioned through engagement of the engaging tongue 32 with the push-push lock 31. Further, this invention has two operating modes for winding the sunshade cloth 13. First, by slightly pulling upward the pull rod 14 so that the engaging tongue 32 can push again the push-push lock 31 and disengage therefrom, the sunshade cloth 13 can be wound automatically by the winding shaft 12. Second, by moving the side window 6 downward to automatically rotate the release arm 41, which in turn, pushes the latch unit 30 to move upward so that the engaging tongue 32 can push again the push-push lock 31 and disengage therefrom. As such, the sunshade cloth 13 can also be wound automatically by the winding shaft 12. The use of the two operating modes is relatively easy. Hence, the present invention is simple, and has a novel structure.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A sunshade assembly comprising:
a housing having a top opening;
a winding shaft mounted rotatably in said housing;
a sunshade cloth wound around said winding shaft;
a pull rod connected to one end of said sunshade cloth that is distal from said winding shaft and disposed outside said top opening;
a guide unit including a base seat disposed below said housing and extending in a top-bottom direction, and a guide rod mounted to and slidable upward and downward along said base seat and having a top end connected to said pull rod; and
a locking mechanism including a push-push lock mounted on said base seat, and a latch unit fixed to said guide rod and having an engaging tongue engageable releasably with said push-push lock;
wherein, when said sunshade cloth is pulled upward by said pull rod from a wound position to a stretched position, said guide rod is moved upward by said pull rod so that said engaging tongue pushes and engages said push-push lock; and
wherein, when said guide rod is moved further upward, said engaging tongue pushes again said push-push lock and disengages therefrom, thereby permitting said sunshade cloth to be wound automatically by said winding shaft from said stretched position to said wound position.

2. The sunshade assembly of claim 1, further comprising a release unit to move upward said latch unit and to disengage said engaging tongue from said push-push lock, said release unit including a release arm disposed rotatably on said base seat proximate to said locking mechanism, and a roller mounted on said release arm, said release arm having a pressed portion, a push portion opposite to said pressed portion, and a pivot portion between said pressed portion and said push portion and connected pivotally to said base seat, said roller being journalled on said pressed portion, wherein, when said roller is pressed downward, said release arm rotates about said pivot portion, and said push portion pushes upward said latch unit so that said engaging tongue pushes again said push-push lock and disengages therefrom.

3. The sunshade assembly of claim 2, wherein said release unit further includes a biasing member mounted between said release arm and said base seat to provide a returning force to said release arm.

4. The sunshade assembly of claim 1, wherein said base seat has a guide groove extending in a top-bottom direction, and a slide hole extending in a top-bottom direction and communicating with said guide groove, said guide rod being slidable in said guide groove, said guide unit further including a slide piece connected to a bottom end of said guide rod and slidable in said slide hole, and two pulleys connected respectively to two opposite sides of said slide piece and contacting rollably said base seat.

5. The sunshade assembly of claim 1, further comprising a damping unit to dampen a downward speed of said guide rod, said damping unit including a hollow damping seat connected to said base seat, a wheel seat connected movably to said damping seat, a damping wheel journalled on said wheel seat and pressing resiliently said guide rod against said base seat, and a spring member mounted between said damping seat and said wheel seat and biasing said damping wheel to move toward said guide rod.

6. The sunshade assembly of claim 5, wherein said damping unit further includes an adjustment screw connected adjustably to said damping seat opposite to said wheel seat, said adjustment screw being rotatable to compress or uncompress said spring member.
